(19) United States
(12) Patent Application Publication
(10) Pub. No.: US 2016/0104222 A1
(43) Pub. Date: Apr. 14, 2016

(54) SYSTEM AND METHOD FOR SELLING AND BUYING VEHICLES

(71) Applicant: Carsavvy INC., Los Altos, CA (US)

(72) Inventors: Omer Savir, Palo Alto, CA (US); Alejandro Resnik, Mountain View, CA (US)

(21) Appl. No.: 14/693,272

(22) Filed: Apr. 22, 2015

Related U.S. Application Data
(60) Provisional application No. 61/982,532, filed on Apr. 22, 2014.

(51) Int. Cl. G06Q 30/06; G06Q 10/00

(52) U.S. Cl. CPC G06Q 30/0611; G06Q 10/20

(57) ABSTRACT

A system comprising a server including a processor and a memory having executable instructions stored thereon that when executed by the processor cause the processor to receive detail data associated with a vehicle from a client device of a seller, retrieve, from third party data servers, retail prices and trade-in prices of vehicles corresponding to the detail data, calculate a marketplace offering price for the vehicle based on the retail and trade-in prices, and transmit the marketplace offering price for the vehicle to the client device of the seller.

### CROSS REFERENCE TO RELATED APPLICATION

This application claims the priority of U.S. Provisional Application No. 61/982,532, entitled “SYSTEM AND METHOD FOR SELLING AND BUYING VEHICLES,” filed on Apr. 22, 2014, the disclosure of which is hereby incorporated by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The invention described herein generally relates to online price discovery, and in particular, aggregating pricing data of used vehicles from third party sources.

2. Description of the Related Art

Advancements in computer and networking technology enable users and entities to conduct various types of activities online via computer-based applications and systems. For example, the Internet has spawned many different websites that enable consumers to search for vehicles and go through the process of communicating with dealerships. An important factor in the purchase considerations is the pricing of the vehicle. Many factors may go into determining a price: manufacturer pricing guidelines, dealer actual costs, the size of available inventory, and the market demand for the vehicle to name a few.

Online car brokers may provide consumers with their broker prices for particular types of vehicles. However, these broker prices may not reflect actual dealership prices and brokers may have to find a dealership that will provide a vehicle that will meet that price. Additionally, if a broker finds a dealership that will provide a lower price than the broker price cited to a consumer, the consumer may not receive the benefit of the lower dealership price. In such situations, when a consumer may purchase a vehicle at a broker price, the consumer may not be certain whether the consumer is receiving the lowest price the consumer could have received from among the dealerships.

Sometimes dealerships may provide dealership prices to consumers for particular vehicles. These vehicles are often listed as actual specified vehicles, including identifying information such as a VIN number. However, such vehicles may sell out quickly, which may prevent a consumer from receiving the quoted price, or a consumer may not wish to purchase the specific listed vehicle. Thus, there is a need for improved systems and methods of vehicle pricing management that may incorporate multiple sources of pricing data and replace the traditional car dealership model.

### SUMMARY OF THE INVENTION

The present invention provides a system comprising a server including a processor and a memory having executable instructions stored thereon that when executed by the processor cause the processor to receive detail data associated with a vehicle from a client device of a seller, retrieve, from third party data servers, retail prices and trade-in prices of vehicles corresponding to the detail data, calculate a marketplace offering price for the vehicle based on the retail and trade-in prices, and transmit the marketplace offering price for the vehicle to the client device of the seller.

In certain embodiments, the processor is operable to receive an acceptance of the marketplace offering price from the client device of the seller, schedule an inspection of the vehicle, generate vehicle listing data corresponding to the vehicle, and store the vehicle listing data in a database. The processor may be further operable to receive, from an inspection client device, inspection data for the inspection of the vehicle, and store the inspection data with the vehicle listing data. According to one embodiment, the marketplace offering price is a maximum between the retail prices and the trade-in prices. The processor may be operable to present the vehicle for sale based on the vehicle listing data. In another embodiment, the processor is operable to retrieve the vehicle listing data, and transmit the vehicle listing data to a client device of a buyer.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a computing system according to an embodiment of the present invention;

FIG. 2 illustrates a flowchart of a method for selling vehicles according to an embodiment of the present invention;

FIG. 3 through FIG. 10 illustrate exemplary user interface for selling vehicles according to an embodiment of the present invention;

FIG. 11 and FIG. 12 illustrate flowcharts of methods for processing vehicle data according to embodiments of the present invention;

FIG. 13 illustrate flowcharts of a method for processing electronic payment according to an embodiment of the present invention; and

FIG. 14 through FIG. 23 illustrates exemplary user interface according to an embodiment of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

Described herein are methods and systems for connecting buyers and sellers of vehicles, eliminating the need for car dealers and car lots. Vehicles, as referred to herein, may include any mobile machine that transports people or cargo such as cars, trucks, water crafts, motorcycles, all-terrain vehicles, wagons, Segways, bicycles, buses, aircrafts, spacecrafts, etc. According to one embodiment, vehicle sellers may provide details of their vehicle(s) for sale on a marketplace server. Vehicles that can be sold using the marketplace server include, but are not limited to, cars, trucks, and other motor vehicles. Agents may be dispatched by the marketplace server to certify or inspect vehicles and set prices. Additionally, when the vehicles are sold to a buyer using the marketplace server, the sold vehicles may be picked up by the agents from the seller and driven or delivered to the buyers of the vehicles. The marketplace server may also handle or manage title, plates, and any other paperwork associated with buying and selling transactions associated with the vehicles.

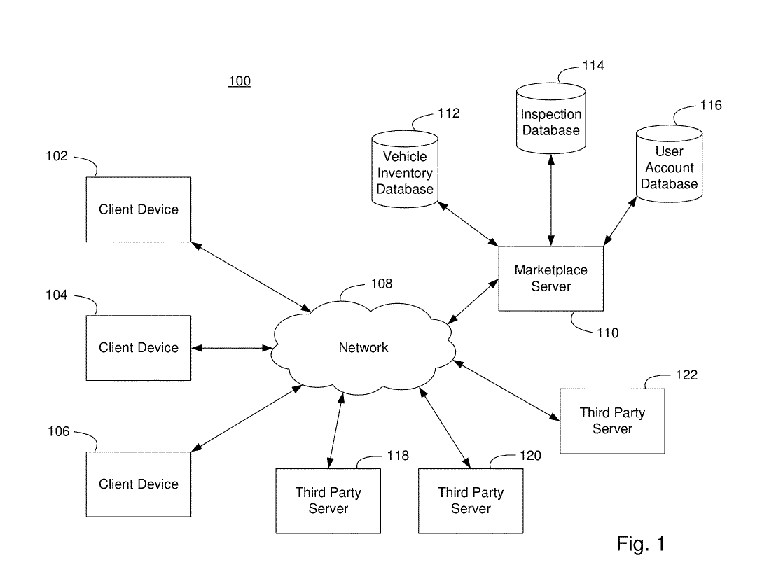

FIG. 1 illustrates a computing system according to an embodiment of the present invention. The system presented in FIG. 1 includes client device 102, client device 104, client device 106, network 108, marketplace server 110, third party server 118, third party server 120 and third party server 122. Client devices 102, 104, and 106 may comprise general purpose computing devices (e.g., personal computers, mobile devices, terminals, laptops, personal digital assistants (PDA), cell phones, tablet computers, e-book readers, or any computing device having a central processing unit and memory unit capable of connecting to a network). Client devices may also comprise a graphical user interface (GUI) or a browser application provided on a display (e.g., monitor screen, LCD or LED display, projector, etc.). A client device may vary in terms of capabilities or features. For example, a web-enabled client device, which may include one or more physical or virtual keyboards, mass storage, one or more accelerometers, one or more gyroscopes, global positioning system (GPS) or other location identifying type capability, or a display with a high degree of functionality, such as a touch-sensitive color 2D or 3D display.

A client device may also include or execute an application to communicate content, such as, for example, textual content, multimedia content, or the like. A client device may also include or execute an application to perform a variety of possible tasks, such as browsing and searching the Internet. The foregoing is provided to illustrate that claimed subject matter is intended to include a wide range of possible features or capabilities. A client device may include or execute a variety of operating systems, including a personal computer operating system, such as a Windows, Mac OS or Linux, or a mobile operating system, such as iOS, Android, or Windows Mobile, or the like. A client device may include or may execute a variety of possible applications, such as a client software application enabling communication with other devices, such as communicating one or more messages, such as via email, short message service (SMS), or multimedia message service (MMS), including via a network, such as a social network, including, for example, Facebook, LinkedIn, Twitter, Flickr, or Google+, to provide only a few possible examples.

Network 108 may be any suitable type of network allowing transport of data communications across thereof. The network 108 may couple devices so that communications may be exchanged, between servers and between servers and client devices or other types of devices, including between wireless devices coupled via a wireless network, for example. A network may also include mass storage, such as network attached storage (NAS), a storage area network (SAN), or other forms of computer or machine readable media, for example. In one embodiment, the network may be the Internet, following known Internet protocols for data communication, or any other communication network, e.g., any local area network (LAN), or wide area network (WAN) connection, wire-line type connections, wireless type connections, or any combination thereof. Communications and content stored and/or transmitted to and from the client devices 102, 104, and 106 may be encrypted using the Advanced Encryption Standard (AES) with a 256-bit key size, or any other encryption standard known in the art.

Marketplace server 110 may vary widely in configuration or capabilities, but generally the marketplace server 110 includes one or more central processing units and memory. The server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like. Marketplace server 110 may comprise one or more processing components disposed on one or more processing devices or systems in a networked environment. The marketplace server 110 may operate in a manner similar to known search, matching, and electronic commerce technologies, but with the inclusion of additional processing capabilities described herein. The marketplace server 110 is operative to receive requests from client devices and process the requests to generate results to the client devices across the network 108. Marketplace server 110 further comprises vehicle inventory database 112, inspection database 114, and user account database 116. Vehicle inventory database may include listings of vehicles for sale by sellers registered with the marketplace server 110. The listings comprise information associated with vehicles for sale including identification of the seller, a description of the vehicle and/or seller, vehicle information (make, model, year, mileage, color, etc.), and pricing. Sellers and buyers of vehicles through marketplace server 110 may create an account with marketplace server 110, where account information is stored in user account database 116. Inspection database 114 includes scheduling information for vehicle inspection of vehicles to be sold on via the marketplace server 110.

In addition, marketplace server 110 may also request or retrieve information from third party servers 118, 120, and 122. Third party servers 118, 120 and 122 include servers associated with information service providers such as third party vehicle dealers, vehicle valuation companies, vehicle history reporting companies, credit bureaus, banks, payment verification, authorization and processing. In addition, the third party servers may be comprised of servers associated with various social networking platforms.

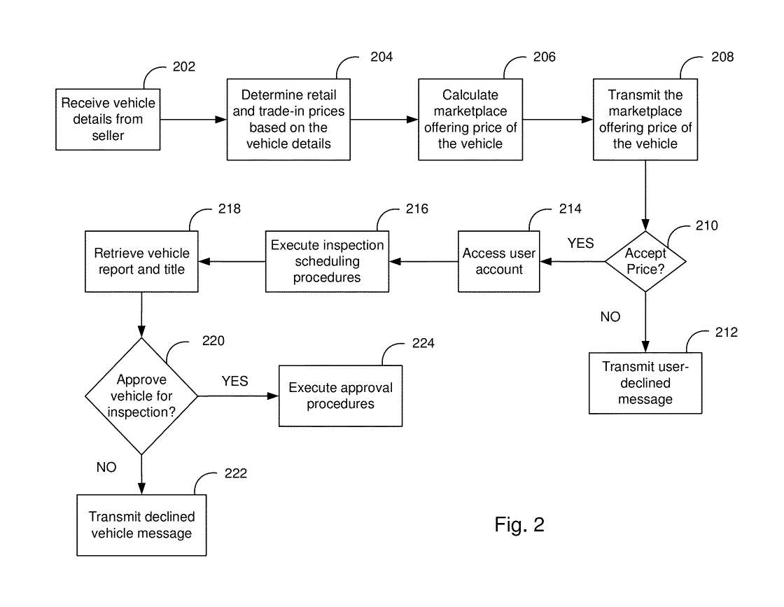

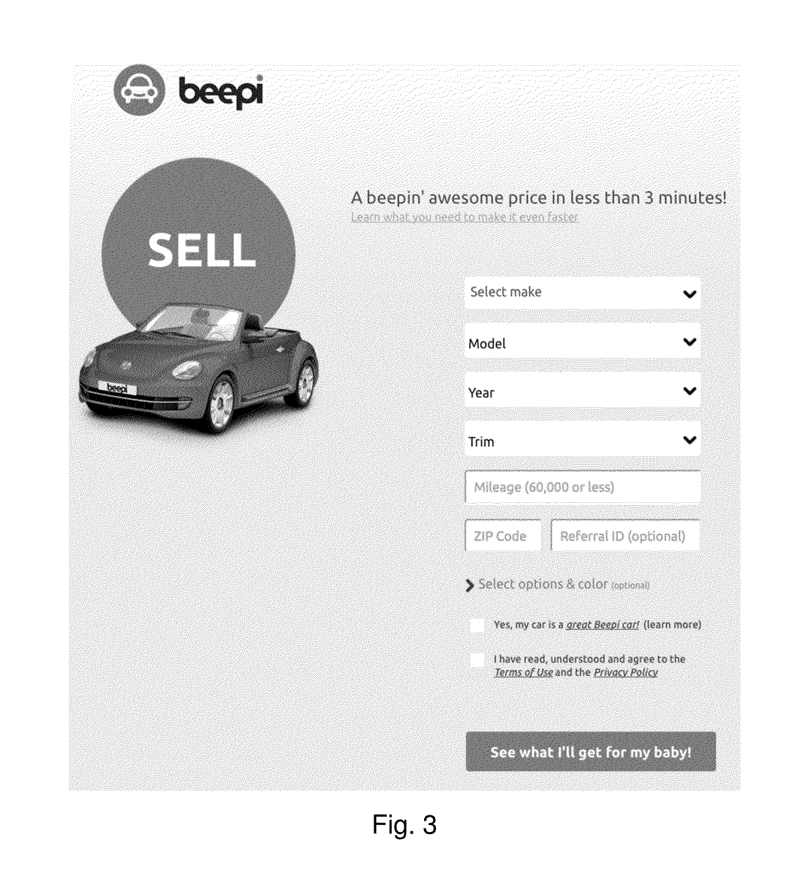

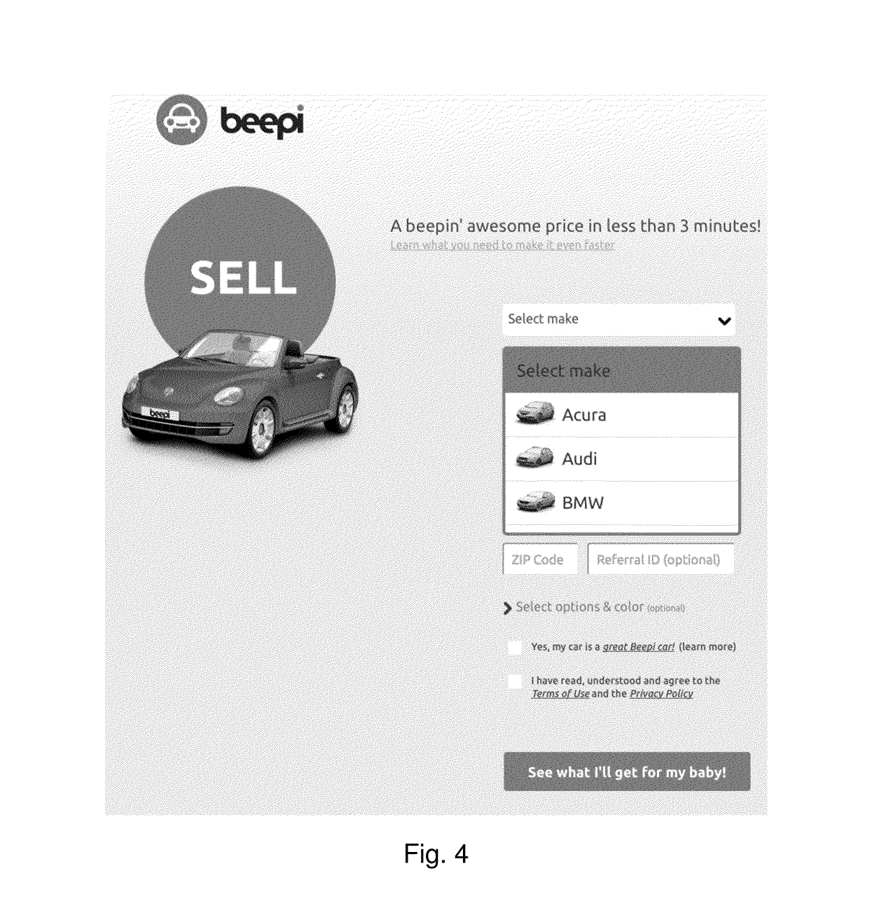

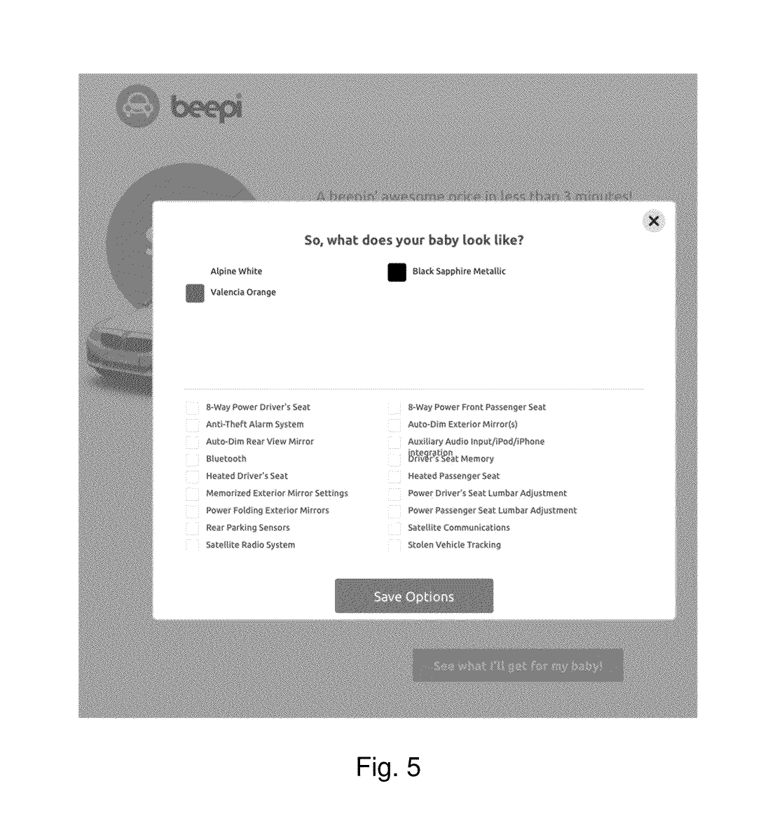

FIG. 2 presents a flowchart of a method for selling vehicles according to an embodiment of the present invention. A seller may sell one or more vehicles on an online marketplace service according to embodiments of the present invention. Vehicle details are received from a seller, step 202. The vehicle details may be transmitted from a client device used by the seller to a marketplace server. FIG. 3 presents an exemplary user interface for the seller to provide details of a vehicle that the seller desires to sell using the marketplace service. The seller may input vehicle details via drop-down menus and text fields, for example, as illustrated in FIG. 4. Information such as make, model, year and trim may be provided to the marketplace service provider via the user interface. Optionally, the user may provide the mileage, zip code, options, and color of the vehicle. FIG. 5 presents an exemplary interface for providing color and options information of the vehicle.

Retail and trade-in prices are determined based on the vehicle details, step 204. The marketplace server is operable to retrieve retail and trade-in prices of vehicles corresponding, matching, or similar to the received vehicle details from one or more third party price data sources and servers. For example, a vehicle appraisal database or service (such as Kelley Blue Book, Edmunds, etc.) and/or local dealership information may be accessed via an application programming interface (API) to determine a dealer retail and/or trade-in price of the vehicle for sale. The marketplace server can use the retail and trade-in prices to calculate a marketplace offering price for the seller's vehicle.

A marketplace offering price of vehicle is calculated, step 206. The marketplace offering price for the seller's vehicle may be calculated by determining the greater of a dealer retail price (less commission) and a minimum offer to seller value based on a published trade-in value of the vehicle. For example, a published trade-in value may be $9,800 and a published dealer retail price may be $15,600 for a vehicle matching the vehicle identified by the seller. A base commission may be determined to be a certain percentage of the published dealer retail price, such as 9% or $1,404. The marketplace server can also set or determine a commission cap, e.g., $599. The dealer retail price less commission may be calculated by subtracting the lesser of the base commission and the commission cap from the published dealer retail price which is $15,000 ($15,600−min($1,404, $599)). The minimum offer to seller value may be a minimum value above the published trade-in value. The marketplace server may determine an exemplary minimum value of $100 above the published trade-in value of $9,800 which results in a minimum offer to seller of $9,900. Hence, in this example, the marketplace offering price quoted for the vehicle is $15,000 (max($15,000, $9,900)). The dealer retail price and the trade-in price may be any one of a given local dealer, an average price of local dealers, or an average price among national dealers that is used as a basis for calculating the marketplace offering price.

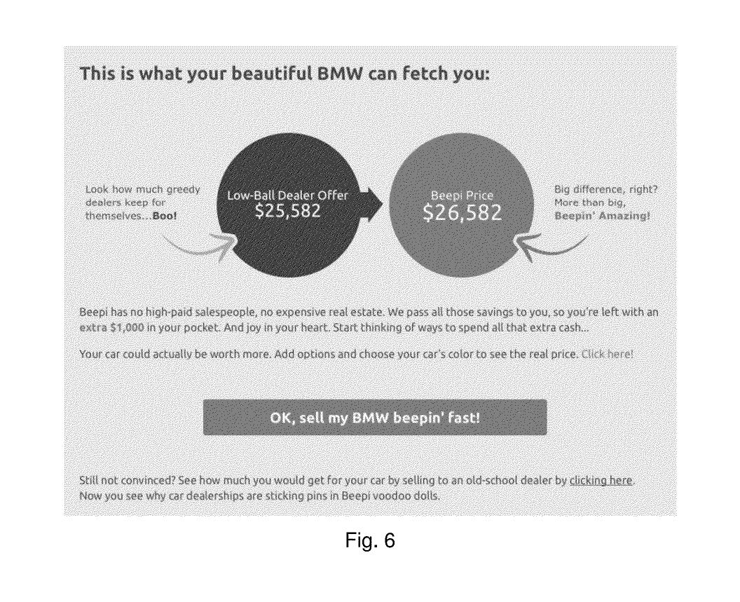

The marketplace offering price of the vehicle is transmitted, step 208. The determined marketplace offering price of the vehicle is transmitted from the marketplace server to the client device of the seller. According to one embodiment, the marketplace offering price of the vehicle may be presented to the seller using a comparison between the dealer retail/trade-in price and the marketplace offering price in a side-by-side presentation (for example, as illustrated in FIG. 6). The comparison may display the difference between the pricing of a local dealer and of the marketplace server. The seller is provided with the option to accept the marketplace offering price for the vehicle, step 210.

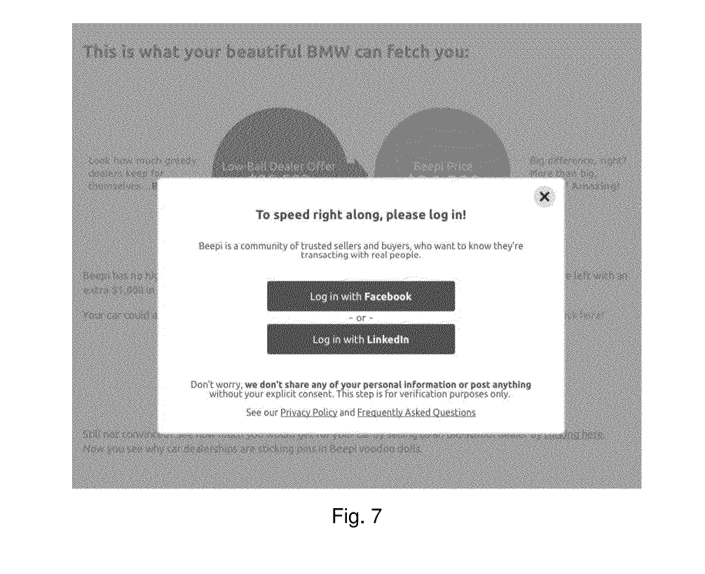

The seller may decline the pricing and the marketplace server will transmit a user-declined message, step 212. On the other hand, if the seller accepts the marketplace offering price, the marketplace server prompts the seller to create or login to an account. The seller may create an account with the marketplace server, or login as an existing user. To create an account, the seller may enter an email and password, or alternatively, use account information from other services such as social networking sites (e.g., Facebook, LinkedIn), for example, as illustrated in FIG. 7.

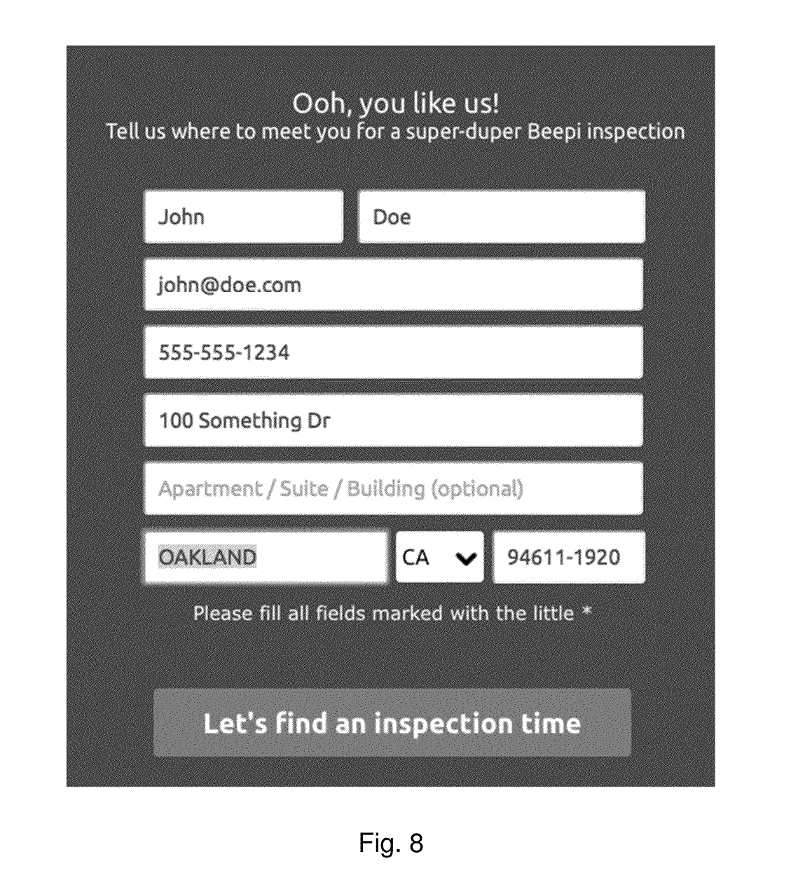

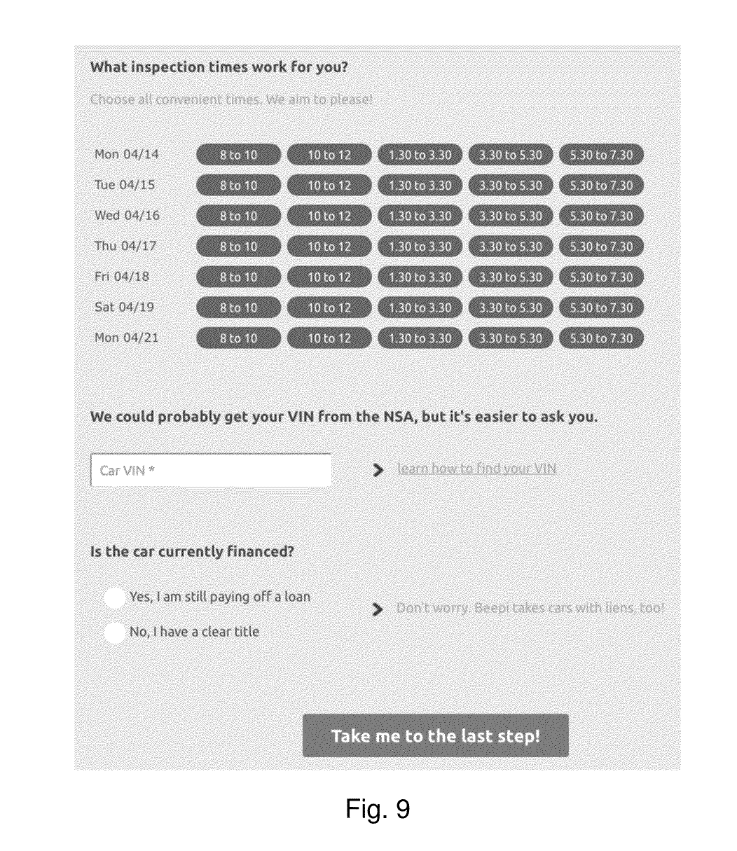

A user account is accessed, step 214 and the marketplace server proceeds to execute inspection scheduling procedures in step 216. The inspection scheduling procedures may include prompting the seller to provide his/her contact information, an address or location of the vehicle, and inspection time preferences to find a time for inspection of the vehicle by an agent (for example, as illustrated in FIG. 8). Available inspection times may be retrieved from an inspection database and presented to the client device of the seller. An interface such as the one illustrated in FIG. 9 may be presented to the client device of the seller to provide the seller with a plurality of dates and time slots that he/she may select for inspection of the vehicle. According to an alternative embodiment, the inspection may be scheduled via an email.

The marketplace server may also prompt the seller to provide a Vehicle Identification Number (VIN) and financing details associated with the vehicle for sale. The VIN may be used to retrieve vehicle history report from a third party (e.g., Autocheck, CarFax, etc.). Financing details may include whether the vehicle is currently financed or has a clear title. The marketplace server can determine and verify whether the title is clean via third party services as well.

A vehicle report and title search is retrieved, step 218. One or more third parties providing vehicle reports and title searches may be contacted or accessed by the marketplace server via an API. A vehicle report and the title of the seller's vehicle may be examined and compared with the vehicle information provided by the seller. Based on the contents of the vehicle report and title search, the marketplace server decides whether or not to approve the vehicle for inspection, step 220.

Rejection of the vehicle for inspection (e.g., if the vehicle report and title contain major issues or inconsistencies) results in transmitting a declined vehicle message to the client device of the seller, step 222. Approval of the vehicle for inspection (e.g., if vehicle report and title verification is successful and/or the vehicle does not have any outstanding issues), results in the execution of approval procedures, step 224. Approval procedures may include the marketplace server transmitting an approval message to the client device of the seller and scheduling inspection of the vehicle as requested by the seller.

An agent may be scheduled and dispatched to the address of the vehicle as specified by the seller. Inspection of the vehicle by the agent may include test driving the vehicle, performing an inspection and taking photographs of the vehicle. The following are exemplary inspection criteria performed by an agent:

Inspection Categories

Standard Information

a. Make/Model
i. # of cylinders
ii. Transmission
   1. Automatic
   2. Manual
iii. Drive
   1. Front wheel drive
   2. Rear wheel drive
   3. All wheel drive
iv. Number of doors
v. Seating capacity
vi. # of keys/operational

b. Paint Color

c. Trim Color

d. Body Type
i. Coupe
ii. Convertible
iii. Sedan
iv. Wagon
v. SUV
vi. Compact SUV
vii. Truck

e. Mileage

f. Vin

Exterior

g. Visual Inspection
i. Hood
ii. Front bumper
iii. Front Valence
iv. Driver side fender
v. Passenger side fender
vi. Driver side headlight
vii. Passenger side headlight
viii. Roof
ix. Driver side door skin
x. Passenger side door skin
xi. Driver side rear door skin
xii. Passenger side rear door skin
xiii. Pillars
xiv. Trunk/Hatch/Tailgate
xv. Rear bumper
xvi. Rear Valence
xvii. Driver side quarter panel
xviii. Passenger side quarter panel
xix. Driver side rocker sill
xx. Passenger side rocker sill
xxi. Driver side tail light
xxii. Passenger side tail light
xxiii. Fuel filler door
xxiv. Front-end body alignment
xxv. Door & body line alignment
xxvi. Rear-end body alignment

h. Functional Inspection
i. Mirrors operate as designed
ii. Door handles operate as designed
iii. Trunk Handle operates as designed
iv. Lights function as designed
v. Headlights
vi. Brake Lights
vii. Turn signals
viii. Hazard Flashers
ix. Backup lights
x. License plate light
xi. Convertible top operates as designed (if applicable)

i. Condition of paint
i. Excellent
ii. Very Good
iii. Good
iv. Fair
v. Poor

j. Signs of collision damage
i. Yes
ii. No

Interior

k. Visual Inspection
i. Door weather seal free of dry rot and damage
ii. Door panels free of defects, stains, damage
iii. Carpet/Floor mats are free of water damage, wear, stains
iv. Trim pieces are free of damage/defects—check dash, center console, doors, etc.
v. Dash and vents are clean and properly dressed
vi. Glovebox and console compartments are free of stains and debris
vii. Cup holders are free of stains and debris
viii. Seats and seat belts are free of stains
ix. Headliner & pillars are free of stains, (water) damage, sagging
x. Trunk interior is free of stains, debris, heavy fragrance
xi. Trunk tools are in the correct location
xii. Trunk floor plan is free of corrosion, rust, damage

l. Functional Inspection
i. Pedals are damage free and function as designed
ii. Interior lights operate as designed
iii. Windows and sunroof operate as designed
iv. Central locks operate as designed
v. Mirrors operate as designed
vi. Gear selector operate as designed
vii. Parking brakes function as designed
viii. Heating/air conditioning operate as designed
ix. Audio/navigation operate as designed
x. All speakers operate as designed
xi. Steering wheel controls operate as designed
xii. Horn functions as designed
xiii. Stalk controls operate as designed
xiv. Cup holders function as designed
xv. Glove box function as designed
xvi. Seats operate as designed
xvii. Seat belts function as designed
xviii. No diagnostic/airbag codes set
xix. OBD readiness monitors set

Engine

m. Mechanical/Visual Inspection
i. Engine is free of leaks—coolant, oil, P/S, A/C
ii. Coolant hoses are free of swelling, leaks, dry rot
iii. Belts/tensioners/pulleys are free of cracks, wear, looseness, glaze, excessive noise
iv. Battery is free of corrosion, swelling, damage
v. Battery cables are free of corrosion, tightness, damage
vi. Coolant level and condition acceptable
vii. Brake fluid level and condition acceptable
viii. P/S fluid level and condition acceptable
ix. Oil level and condition acceptable
x. Carrying rails and firewall are free of damage/body work
xi. No signs of body dust and panels align properly
xii. Factory painted bolts and body hinges are free of indication that body work has been performed
xiii. Engine is free of odors while running

Wheel Assembly

n. Visual Inspection
i. Tires are free of damage—sidewall damage, scalloping, uneven tire wear
ii. Tires brands are matching
iii. Rims free of damage, cracks, dents
iv. All lug nuts/bolts present
v. All wheels have wheel locks and key
vi. Spare tire present
vii. Brake lining check—condition of rotors/pads
viii. Brake hose check—dry rot, cracks
ix. Suspension bounce test—vehicle sits level

o. Brake Lining
i. L/F WHEEL
   1. 0-3 MM
   2. 3-5 MM
   3. 5-10 MM
ii. R/F WHEEL
   1. 0-3 MM
   2. 3-5 MM
   3. 5-10 MM
iii. L/R WHEEL
   1. 0-3 MM
   2. 3-5 MM
   3. 5-10 MM
iv. R/R WHEEL
   1. 0-3 MM
   2. 3-5 MM
   3. 5-10 MM

p. Tire Pressures/Depth
i. L/F WHEEL
ii. R/F WHEEL
iii. L/R WHEEL
iv. R/R WHEEL

Underbody/Undercarriage

q. Visual Inspection
i. Undercarriage free of leaks, rust, damage
ii. Engine free of leaks, rust, damage
iii. Transmission free of leaks, rust, damage
iv. Transfercase free of leaks, rust, damage
v. Differential free of leaks, rust, damage
vi. Axles free of leaks, rust, damage
vii. Suspension components free of leaks, rust, damage
viii. Shocks free of leaks, rust, damage
ix. Control arms free of rust, damage, excessive play
x. Tie rods free of rust, damage, excessive play
xi. Exhaust system free of leaks, rust, damage

Vehicle road test

r. Engine Performance
i. Cold engine operation performs properly
ii. Throttle operates properly during cold start
iii. Vehicle operates properly during warm-up conditions
iv. Engine performs properly during operating temperature
v. Engine fan(s) operate properly
vi. No abnormal noise or vibration from engine

s. Transmission Performance
i. Transmission/Clutch operates properly with no slipping
ii. Automatic transmission shifts properly during cold temperature
iii. Automatic transmission shifts properly during warm up temperature
iv. Automatic transmission operates properly during operating temperature

t. Steering/Suspension
i. Steering has normal feel in lock-to-lock turning
ii. Vehicle drives straight on level surface
iii. Vehicle does not pull to the side when applying brakes
iv. Steering wheel centered
v. No abnormal noise or vibration from suspension
vi. No abnormal tire noise/road noise
vii. No abnormal squeaks and rattles from interior

Information gathered by the agent from the inspection may be uploaded (from the agent's client device or from an inspection client device, etc.) to the marketplace server where such information may be recorded in a database entry corresponding to a listing of the vehicle. The agent may be a certified inspector or trained to inspect the vehicle according to certain standards required by the marketplace server. After the agent visit, a price confirmation may be sent to the seller (e.g., via an email). Once the vehicle is purchased by a buyer, an agent may be dispatched to retrieve the vehicle from the seller. The marketplace server may coordinate shipping, transfer ownership, and any other paperwork to finalize the sale and purchase transaction.

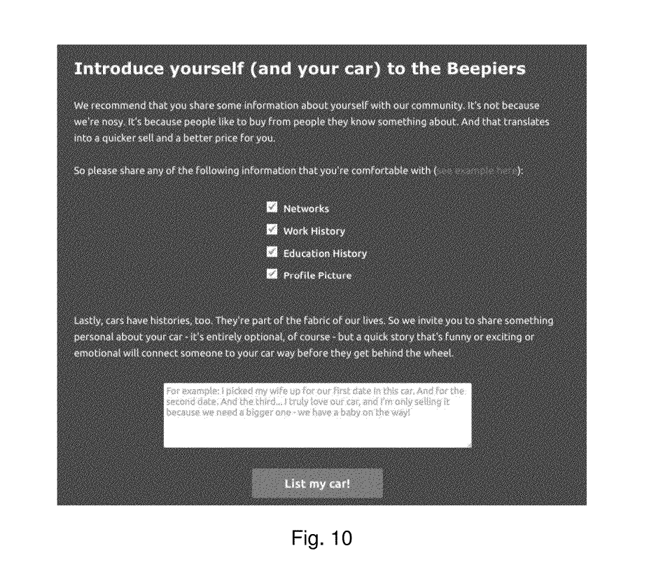

The marketplace server may generate an entry identifying the vehicle and store the entry in a vehicle inventory database. The seller may additionally provide a description of the vehicle and/or of the seller to be included in a listing of the vehicle on marketplace server (for example, as illustrated in FIG. 10). The description of the seller may include information such as network affiliations, work history, education history, a profile picture, and any other personal information or stories.

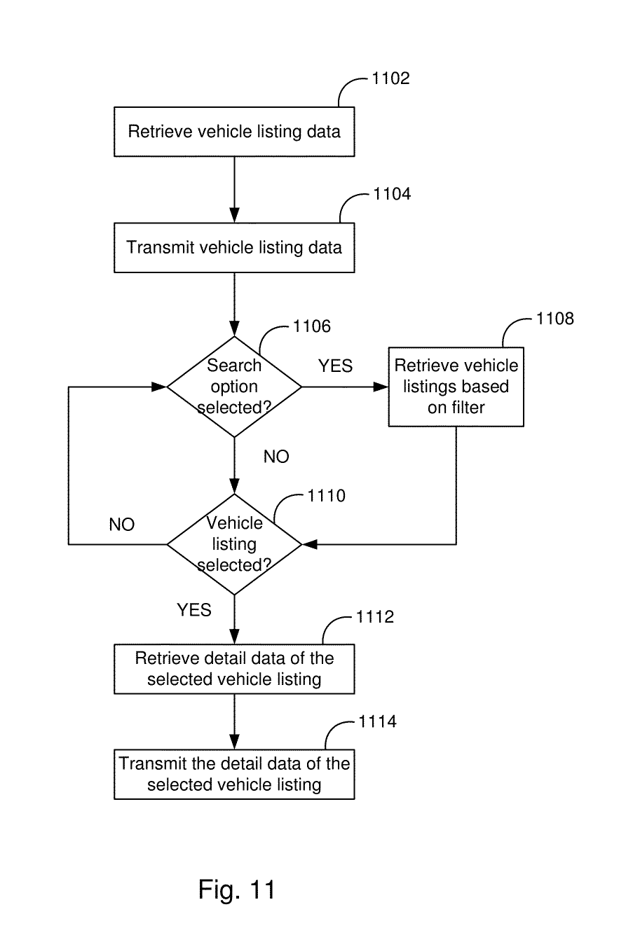

FIG. 11 presents a flowchart of a method for processing vehicle data according to an embodiment of the present invention. The marketplace server includes a vehicle inventory database containing listings of vehicles for sale by sellers that can be retrieved by buyers. Buyers may access the marketplace server via a website to view and purchase vehicles listed by sellers. The marketplace server is operable to provide the buyers with listings of vehicles for sale by sellers. Vehicle listing data is retrieved, step 1102. All or any predetermined amount of vehicle listings (e.g., 20 vehicle listings) may be retrieved in the vehicle listing data from a database of vehicle listings.

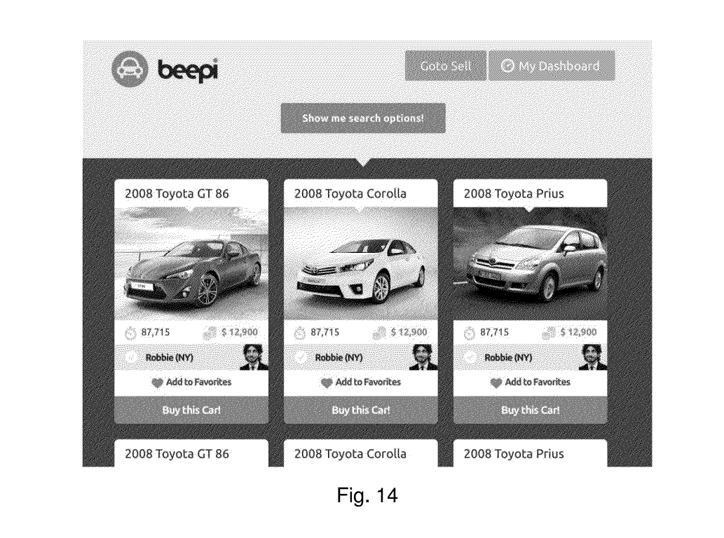

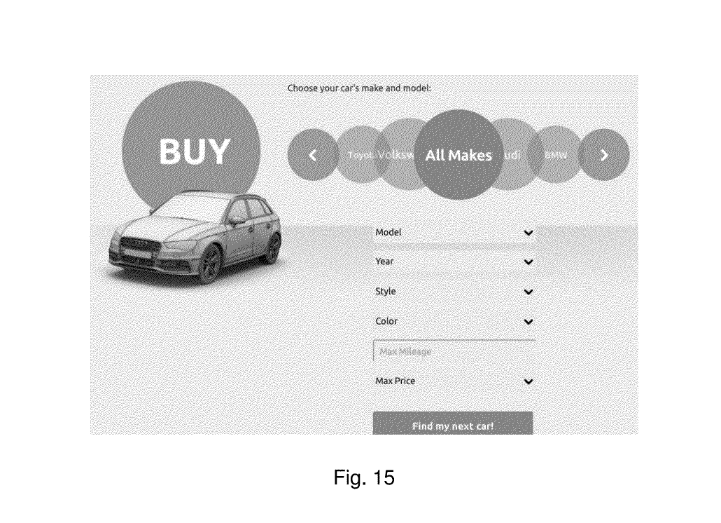

The vehicle listing data is transmitted to a client device of the buyer, step 1104. An exemplary interface is illustrated in FIG. 14 which includes vehicle listings that may be transmitted and presented to a client device of the buyer. Optionally, the presented vehicle listing data may be sorted according to one or more criteria such as popularity, age, price, mileage, seller, etc. A search option is available for selection by the buyer. The marketplace server monitors for selection of the search option, step 1106. A search option may be selected by the buyer to filter the retrieved vehicle listing data. The buyer may search for a vehicle for sale based on certain criteria. For example, a filter option is provided to the buyer to search a vehicle inventory database by makes, models, trims, and years (for example, as illustrated in FIG. 15).

If the search option is selected, another set of vehicle listings are retrieved from the vehicle database based on a filter specified in the search option including one or more criteria, step 1108. Alternatively, the existing retrieved data may be filtered based according to the filter. Listings of vehicles for sale that match criteria from the filter option may be retrieved and presented to the client device of the buyer.

Each vehicle listing that is transmitted and presented to the buyer may be selected. The marketplace server monitors for selection of a given vehicle listing, step 1110. If a vehicle listing is selected, detail data of the selected vehicle is retrieved, step 1112. In a subsequent step 1114, the detail data of the selected vehicle is transmitted to the client device of the buyer. Detail data of a selected vehicle may include information such as the make, model, year, mileage, inspection details, price, and photos. The detail data may also include additional information of the selected vehicle such as a 185 point inspection report, the profile of the inspector who inspected the vehicle, a vehicle history report, and professional pictures of the vehicle may also be displayed in the window. According to one embodiment, the buyer may also be able to ask an agent or inspection any other question the buyer may have about the vehicle not included in the information provided to the buyer.

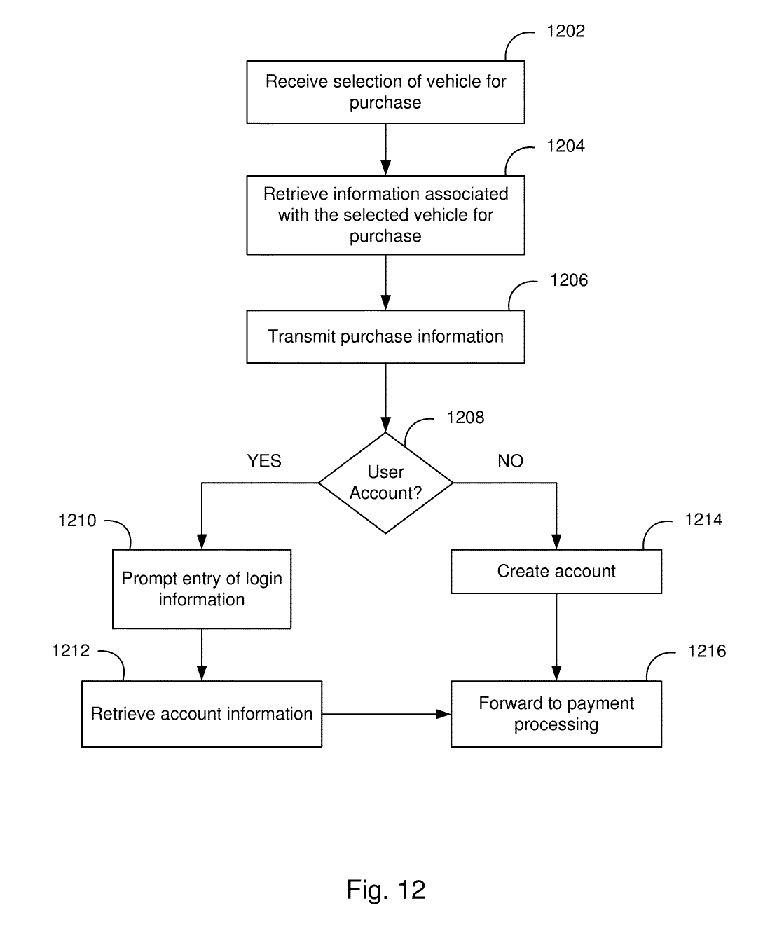

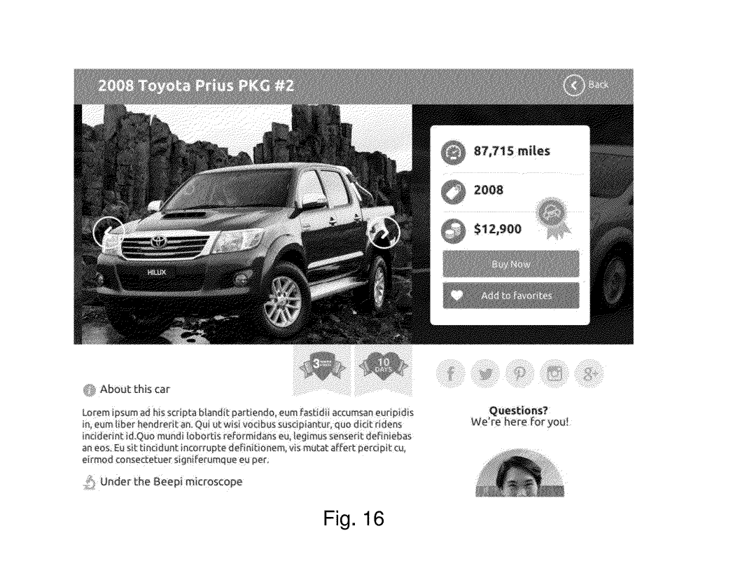

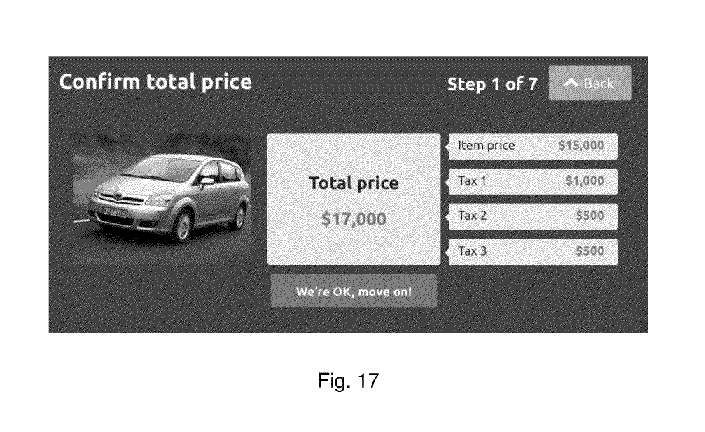

If a buyer is interested in a given vehicle, the buyer may select the vehicle for purchase and a window may be displayed including the vehicle's make, model, trim and year (e.g., as illustrated in FIG. 16). Referring to FIG. 12, a selection of a vehicle for purchase is received, step 1202. The selection may be received by the marketplace server from a client device of a buyer. Information associated with the selected vehicle for purchase is retrieved, step 1204. The marketplace server may retrieve the information for the selected vehicle from a vehicle database. In a subsequent step 1206, purchase information of the selected vehicle is transmitted to the client device of the buyer. The marketplace server may display the total price of the vehicle. The total price includes a base price of the vehicle (which may be retrieved from the vehicle inventory database) along with taxes, fees (e.g., Department of Motor Vehicles (DMV) registration fees calculated via authorized 3rd party DMV agent) and shipping charges based on the location of the buyer (FIG. 17). Transmitting the purchase information may further include providing a 185 PPi (pre-purchase inspection) inspection report, displaying an inspector profile, a vehicle history report (e.g., CarFax), photographs of the car taken by the inspector, and an “ask the inspector section” which allows for the buy to ask the inspector a question about the vehicle.

The buyer is prompted for a user account, step 1208. The buyer may be prompted to enter login information with the marketplace server. The buyer may provide create an account or login as an existing user. If the buyer has an account, the buyer is prompted for entry of login information on their client device, step 1210. Following entry of correct login information, account information is retrieved, step 1212. Otherwise, if the buyer does not have an account with the marketplace server, an account is created for the buyer, step 1214. Creating the account may include prompting the buyer for an email and password, or alternatively, use account information from other services such as from social networking sites. Upon successful login (step 1212) or account creation (step 1214), the client device of the buyer is forwarded to payment processing, step 1216.

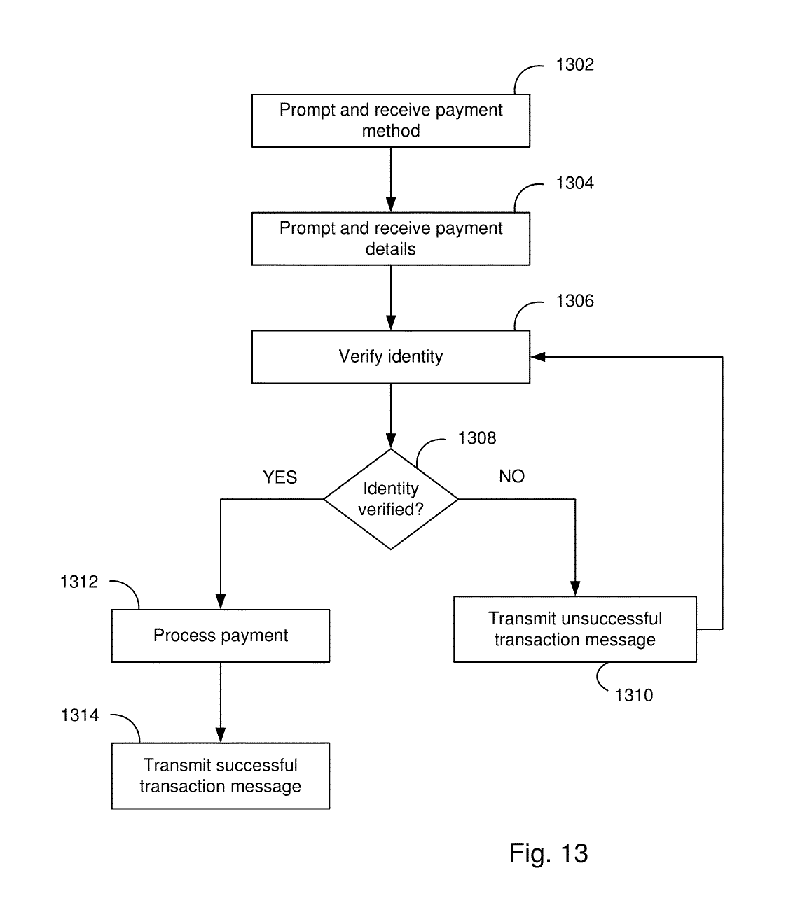

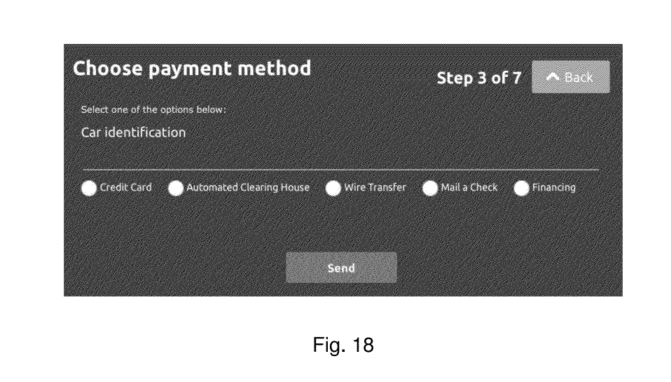

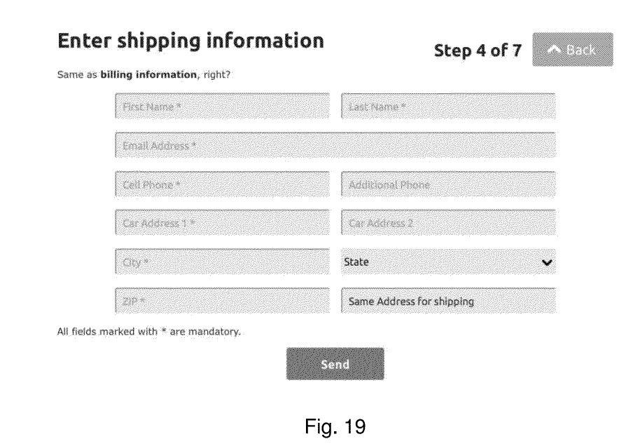

FIG. 13 illustrates a flowchart of a method for processing electronic payment according to an embodiment of the present invention. Payment method for a vehicle selected for purchase is prompted for and received, step 1302. The marketplace server may present the buyer with a selection of a plurality payment methods including credit card, Automated Clearing House (ACH), wire transfer, check, or financing (for example, FIG. 18). Prompting for the payment method includes requesting shipping and billing information/addresses from the buyer. FIG. 19 presents an exemplary interface for entering shipping/delivery/dropoff addresses.

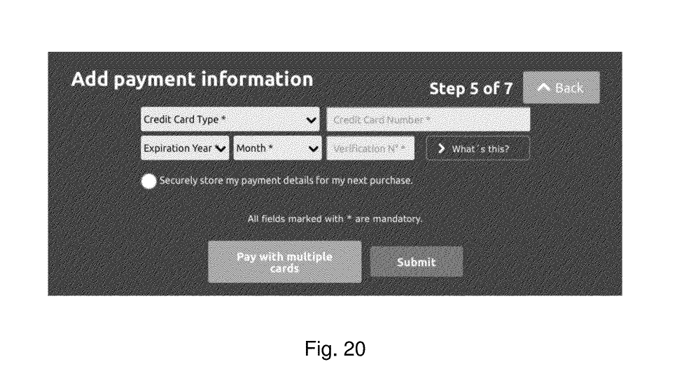

Payment details are received, step 1304. Payment details include information for ACH, credit card, check and financing payments, or wire transfer information. The buyer is prompted to complete payment detail based on a payment method selected by the buyer, as illustrated in FIG. 20. The marketplace server may setup or establish connections according to the payment details via, for example, balanced payments API, FedEx API (e.g., shipping integration with the marketplace server to determine status of a check delivery), and bank API.

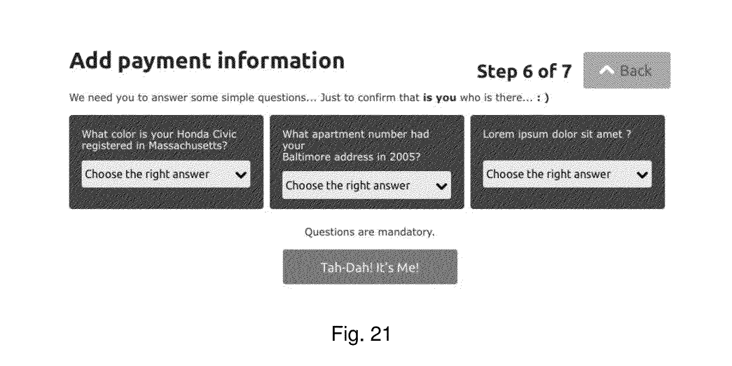

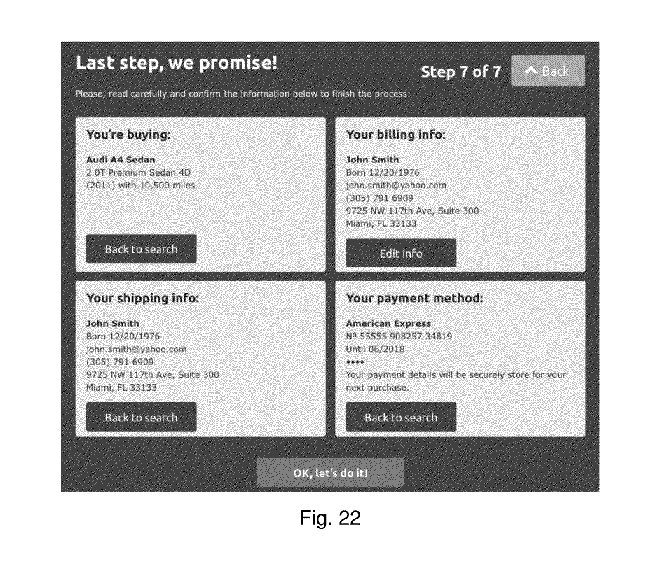

The identity of the buyer is verified, step 1306. A buyer may be asked to verify their identity by answering security questions provided by, for example, a bank, credit agency, etc. (FIG. 21). Verifying the identity of the buyer may also include confirming the purchase of the selected vehicle and accuracy of the information provided by the buyer in a window such as the one illustrated in FIG. 22. A determination that the buyer's identity cannot be verified, step 1308, an unsuccessful transaction message is transmitted to the client device of the buyer, step 1310, and may try again to verify the buyer's identity.

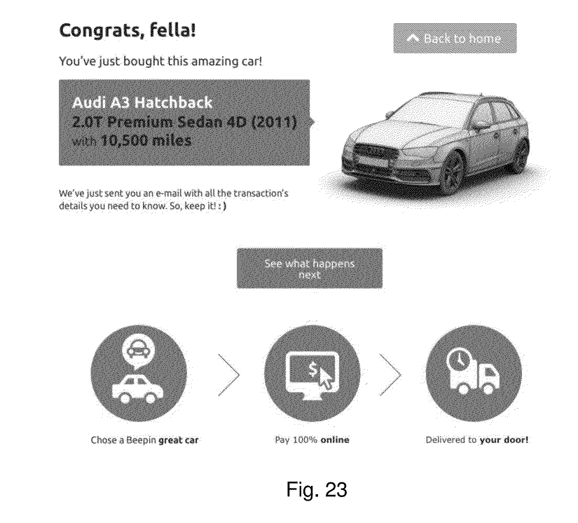

If the buyer's identity is verified, the payment is processed, step 1312. Payment processing may include transmitting the payment information to the appropriate payment gateway. In addition, the listing of the purchased vehicle may be removed from the vehicle database and an agent can be dispatched to pick up the vehicle from the seller. A successful transaction message is transmitted to the client device of the buyer, step 1314. Upon confirmation by the buyer, a confirmation screen (such as the one illustrated in FIG. 23) may be displayed and a confirmation email may also be transmitted to an email account of the buyer.

FIGS. 1 through 23 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A system comprising:
a server including a processor and a memory having executable instructions stored thereon that when executed by the processor cause the processor to:
receive detail data associated with a vehicle from a client device of a seller;
retrieve, from third party data servers, retail prices and trade-in prices of vehicles corresponding to the detail data;
calculate a marketplace offering price for the vehicle based on the retail and trade-in prices; and
transmit the marketplace offering price for the vehicle to the client device of the seller.

2. The system of claim 1 wherein the processor is further operable to:
receive an acceptance of the marketplace offering price from the client device of the seller;
schedule an inspection of the vehicle;
generate vehicle listing data corresponding to the vehicle; and
store the vehicle listing data in a database.

3. The system of claim 2 wherein the processor is further operable to:
receive, from an inspection client device, inspection data for the inspection of the vehicle; and
store the inspection data with the vehicle listing data.

4. The system of claim 1 wherein the marketplace offering price is a maximum between the retail prices and the trade-in prices.

5. The system of claim 1 wherein the processor is further operable to present the vehicle for sale based on the vehicle listing data.

6. The system of claim 1 wherein the processor is further operable to:
retrieve the vehicle listing data; and
transmit the vehicle listing data to a client device of a buyer.
